(19) United States
(12) Patent Application Publication
(10) Pub. No.: US 2026/0202035 A1
(43) Pub. Date: Jul. 16, 2026

(54) LAMP FOR VEHICLE

(71) Applicant: HYUNDAI MOBIS CO., LTD., Seoul (KR)

(72) Inventors: Hyun Hwa LEE, Yongin-si (KR); Ah Ryeong AN, Yongin-si (KR)

(73) Assignee: HYUNDAI MOBIS CO., LTD., Seoul (KR)

(21) Appl. No.: 19/445,411

(22) Filed: Jan. 9, 2026

(30) Foreign Application Priority Data
Jan. 10, 2025 (KR) 10-2025-0004310

(51) Int. Cl. F21S 43/20; F21S 43/145; F21S 43/40; F21W 103/60; F21W 104/00

(52) U.S. Cl. CPC F21S 43/2817; F21S 43/145; F21S 43/26241; F21S 43/26411; F21S 43/2811; F21S 43/401; F21W 2103/60; F21W 2104/00

(57) ABSTRACT

The present disclosure provides a vehicle lamp. The vehicle lamp includes a light source configured to emit light, and an outer lens disposed forward of the light source in a propagation direction of the light emitted from the light source, wherein the outer lens is configured to transmit the light emitted from the light source, and has a thickness that varies in a vertical direction, such that the single outer lens is used as a lens installed in the lamp for a vehicle to implement a three-dimensional effect and a gradation pattern, thereby removing structural complexity, simplifying a manufacturing process, and miniaturizing an optical system.

### CROSS-REFERENCE TO RELATED APPLICATION

This application claims priority to and the benefit of Korean Patent Application No. 10-2025-0004310 filed in the Korean Intellectual Property Office on January 10, 2025, the entire contents of which are incorporated herein by reference for all purposes.

### TECHNICAL FIELD

The present disclosure relates to a lamp for a vehicle, and more particularly, to a lamp for a vehicle in which a single outer lens is used as a lens installed in a lamp for a vehicle to implement a three-dimensional effect and a gradation pattern, thereby removing structural complexity, simplifying a manufacturing process, and miniaturizing an optical system.

### BACKGROUND

A rear lamp is installed on a rear side of a main body of a vehicle. The rear lamp provides information related to traveling situations of the vehicle, such as direction turning, stopping, and reversing of the vehicle, to a driver of a following vehicle.

In general, the rear lamp may include a tail lamp, a stop lamp, a reversing lamp, and the like. The rear lamp may be integrated and installed in a housing.

Recently, in the related art, rear lamps capable of implementing various patterns have been developed to differentiate designs. Among the rear lamps, there is a need to develop a technology related to the rear lamp capable of implementing a three-dimensional effect and a gradation pattern.

Therefore, the rear lamps in the related art sometimes use film technologies in order to implement specific patterns. However, there is a problem in that this technology requires a separate outer lens and is accompanied by a complicated process and a complicated assembling structure.

Further, because a technology using binocular parallax is a technology using an optical illusion rather than an actual 3D image, there is a problem in that a stereoscopic effect deteriorates.

Accordingly, there is a need for a study on a technology related to an optical system capable of maximizing a three-dimensional effect and a gradation pattern while simplifying a structure to prevent structural complexity even though the outer lens is used for the rear lamp for a vehicle.

### SUMMARY

The present disclosure has been made in an effort to provide a lamp for a vehicle in which a single outer lens is used as a lens installed in a lamp for a vehicle to implement a three-dimensional effect and a gradation pattern, thereby removing structural complexity, simplifying a manufacturing process, and miniaturizing an optical system.

In one general aspect, a vehicle lamp includes a light source configured to emit light; and an outer lens disposed forward of the light source in a propagation direction of the light emitted from the light source, wherein the outer lens is configured to transmit the light emitted from the light source, and has a thickness that varies in a vertical direction.

In some embodiments, the thickness of the outer lens may increase or decrease in a stepwise manner along a height direction of the outer lens when the outer lens is oriented vertically.

In some embodiments, a light transmittance reduction portion configured to reduce light transmittance may be provided in a boundary region where the thickness of the outer lens varies.

In some embodiments, the light transmittance reduction portion may include a blocking member applied or printed with a predetermined thickness on a surface of the boundary region and configured to block forward transmission of the light.

In some embodiments, the light transmittance reduction portion may include a protruding member protruding from a surface of the boundary region in a thickness direction of the outer lens; and a blocking member applied or printed at an end of the protruding member opposite to an emission direction of the light and configured to block forward transmission of the light.

In some embodiments, a thickness of the protruding member in the vertical direction may be smaller or larger than a thickness of a recessed portion in the vertical direction.

In some embodiments, the boundary region, on which the blocking member is applied or printed with a predetermined thickness, may have an indented portion recessed inward.

In some embodiments, the blocking member may be formed in a predetermined pattern configured to allow perception of a three-dimensional effect when the light passes through the outer lens.

In some embodiments, the lamp may further include a second lens installed in front of the outer lens and configured to uniformly reduce light transmittance along the propagation direction of light generated from the light source.

In some embodiments, the light source may include a surface light emitter configured to emit light along a predetermined height.

In some embodiments, the light source may include an indirect reflective surface optical system in which the light is emitted from one side thereof, a reflector is configured to reflect the emitted light forward, and a light diffusion film is disposed forward of the reflector.

According to the vehicle lamp described above, the single outer lens is used as a lens installed in the lamp for a vehicle to implement a three-dimensional effect and a gradation pattern, thereby removing structural complexity, simplifying the manufacturing process, and miniaturizing the optical system.

### BRIEF DESCRIPTION OF THE DRAWINGS

FIG. 1 is a longitudinal sectional view illustrating a structure of a lamp for a vehicle according to a first embodiment of the present disclosure.

FIG. 2 is a longitudinal sectional view illustrating a structure of a lamp for a vehicle according to a second embodiment of the present disclosure.

FIG. 3 is a longitudinal sectional view illustrating a structure of a lamp for a vehicle according to a third embodiment of the present disclosure.

FIG. 4 is a longitudinal sectional view illustrating a structure of a lamp for a vehicle according to a fourth embodiment of the present disclosure.

FIG. 5 is a top plan view illustrating the structure of the lamp for a vehicle according to the present disclosure when viewed from the front side.

FIG. 6 is a top plan view illustrating another embodiment of a light source that constitutes the lamp for a vehicle according to the present disclosure.

FIG. 7 is a top plan view illustrating the structure in which a second lens is arranged in the lamp for a vehicle according to the present disclosure

### DETAILED DESCRIPTION

Hereinafter, a lamp for a vehicle according to an embodiment of the present disclosure will be described in more detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression "at least one (or one or more) of A, B, and C" may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being 'connected,' 'coupled,' or 'attached' to another constituent element, one constituent element may be connected, coupled, or attached directly to another constituent element or connected, coupled, or attached to another constituent element through still another constituent element interposed therebetween.

In addition, the expression "one constituent element is provided or disposed above (on) or below (under) another constituent element" includes not only a case in which the two constituent elements are in direct contact with each other, but also a case in which one or more other constituent elements are provided or disposed between the two constituent elements. The expression "above (on) or below (under)" may mean a downward direction as well as an upward direction based on one constituent element.

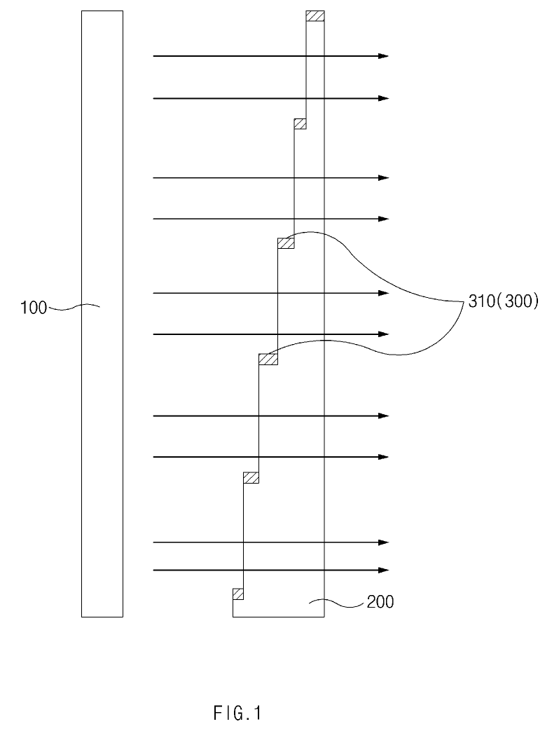

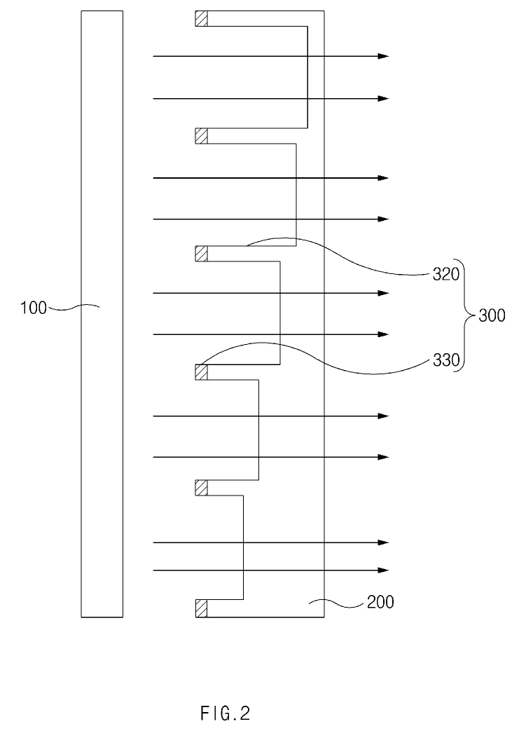

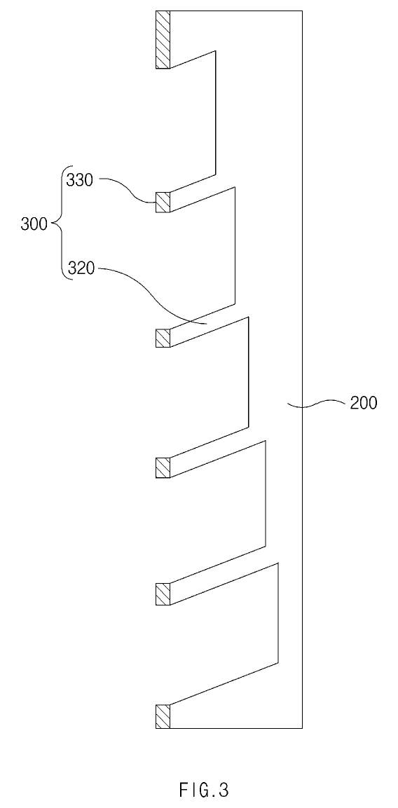

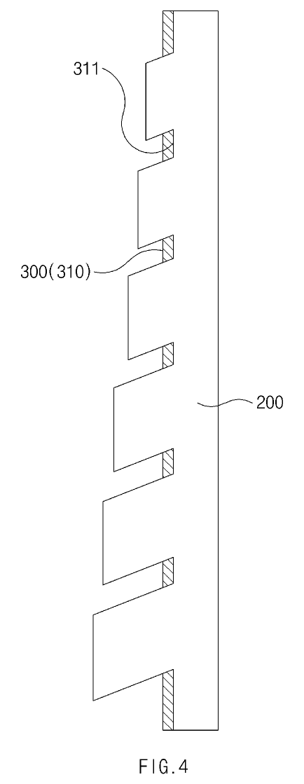

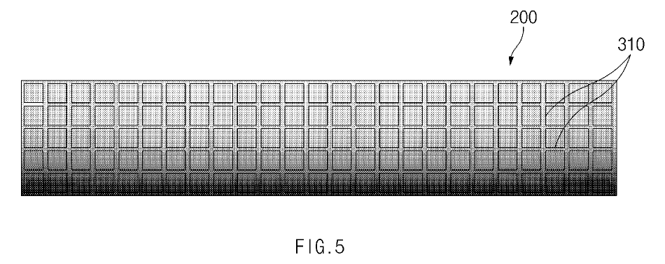

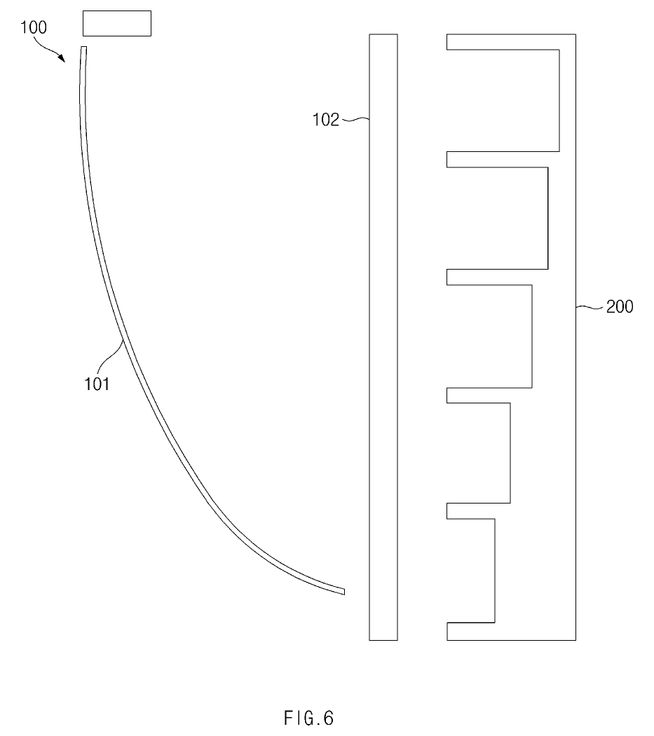

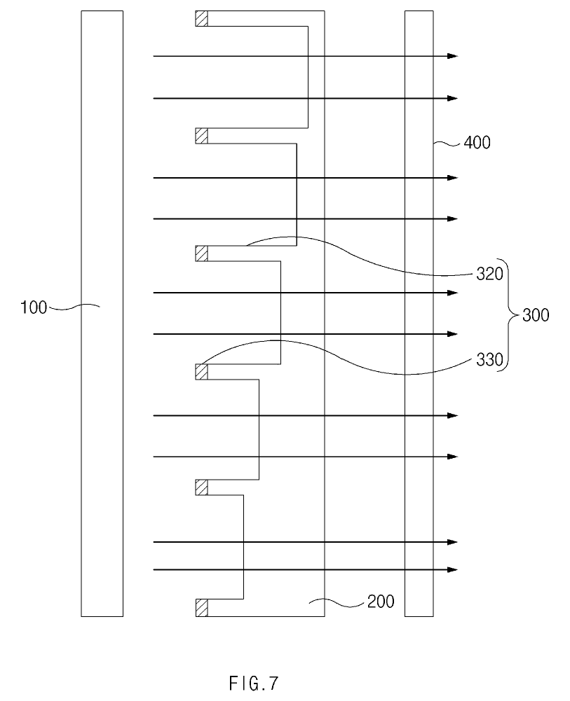

FIG. 1 is a longitudinal sectional view illustrating a structure of a lamp for a vehicle according to a first embodiment of the present disclosure, FIG. 2 is a longitudinal sectional view illustrating a structure of a lamp for a vehicle according to a second embodiment of the present disclosure, FIG. 3 is a longitudinal sectional view illustrating a structure of a lamp for a vehicle according to a third embodiment of the present disclosure, FIG. 4 is a longitudinal sectional view illustrating a structure of a lamp for a vehicle according to a fourth embodiment of the present disclosure, FIG. 5 is a top plan view illustrating the structure of the lamp for a vehicle according to the present disclosure when viewed from the front side, and FIG. 6 is a top plan view illustrating another embodiment of a light source that constitutes the lamp for a vehicle according to the present disclosure, FIG. 7 is a top plan view illustrating the structure in which a second lens is arranged in the lamp for a vehicle according to the present disclosure

As illustrated in FIG. 1, the lamp for a vehicle according to the present disclosure includes a light source 100 configured to emit light, and an outer lens 200 disposed forward of the light source 100 based on a propagation direction of the light emitted from the light source 100, the outer lens 200 being configured to transmit the light, which is emitted from the light source 100, and having a thickness that varies in an upward/downward direction.

First, the light source 100 serves to receive electric power and emit light. The light source 100 of the lamp for a vehicle according to the present disclosure may be provided as a surface light emitter that emits predetermined light along a predetermined height.

The surface light emitter may have any shape as long as the surface light emitter may emit predetermined light in a height direction. The surface light emitter may have a shape in which a plurality of LEDs are disposed. As illustrated in FIG. 6, the surface light emitter may emit light at one side, and a reflector 101 configured to reflect the light forward may be provided. The surface light emitter may be configured as an indirect reflective surface optical system having a shape in which a light diffusion film 102 is disposed forward of the reflector 101.

As described above, the outer lens 200 may be disposed forward of the light source 100 based on the propagation direction of the light emitted from the light source 100. The outer lens 200 may transmit the light emitted from the light source 100 and have a thickness that varies in the upward/downward direction.

The outer lens 200 may be formed to have a thickness that varies in the upward/downward direction, thereby implementing a three-dimensional effect and a gradation pattern when the light passes through the outer lens 200.

To this end, in a state in which the outer lens 200 is disposed uprightly, the thickness of the outer lens 200 may increase or decrease upward in the height direction in a stepwise manner.

One side surface of the outer lens 200 may be stepped so that the thickness of the outer lens 200 varies, such that boundaries may be formed in a region in which the height varies, thereby forming a desired pattern.

If one side surface of the outer lens 200 is not stepped but tapered so that a height of the outer lens 200 gradually varies when the outer lens 200 is formed to have different thicknesses, a boundary region cannot be formed, and a pattern cannot be formed when the outer lens 200 is viewed from the front side.

That is, in case that the outer lens 200 is tapered and thus has a shape extending linearly and continuously, there is no significant difference in change in height between two opposite sides in a boundary region in which a pattern needs to be formed, and as a result, the boundary region cannot be distinctly formed. Therefore, it is effective that one side surface of the outer lens 200 is stepped.

Further, in order for the pattern to be formed more clearly, light transmittance reduction portions 300 configured to reduce light transmittance may be provided in the boundary region in which the thickness of the outer lens 200 varies.

As illustrated in FIG. 1, the light transmittance reduction portion 300 may include a blocking member 310 applied or printed with a predetermined thickness onto a lateral surface of the boundary region and configured to block forward transmission of the light.

As illustrated in FIG. 2, the light transmittance reduction portion 300 may include a protruding member 320 protruding from the lateral surface of the boundary region in the thickness direction of the outer lens 200, and a blocking member 330 applied or printed at an end of the protruding member 320 opposite to an emission direction of the light and configured to block the forward transmission of the light.

In this case, it is effective that the blocking members 310 and 330 printed or applied on the boundary region may each be made of a material capable of efficiently and precisely reducing glare. It is effective that the blocking members 310 and 330 are selectively printed or applied so that the light transmittance of the blocking members 310 and 330, through which light passes, is at a level desired by a user.

Further, as illustrated in FIG. 3, in case that the light transmittance reduction portion 300 includes the protruding member 320 and the blocking member 330, the region, through which the light directly passes, has a debossed shape recessed, such that a thickness of the protruding member 320 in the upward/downward direction may be smaller or larger than a thickness of a recessed portion in the upward/downward direction.

In case that the region, through which the light directly passes, is debossed, the protruding member 320 may be formed to be inclined, such that a route, through which light passes, is longer than a route defined in case that the protruding member 320 is formed in a perpendicular direction, thereby forming a gradation pattern by changing the transmittance.

In addition, as illustrated in FIG. 4, the boundary region, in which the blocking members 310 constituting the light transmittance reduction portions 300 are applied or printed with a predetermined thickness, may have indented portions 311 recessed inward, such that the outer lens 200 may have an embossed shape.

In case that the outer lens 200 is formed in an embossed shape as described above, the region, through which the light directly passes, may be formed to be inclined, such that a route, through which light passes, is longer than a route defined in case that the region is formed in the perpendicular direction, thereby forming a gradation pattern.

Further, as illustrated in FIG. 5, the blocking members 310 and 330 may be formed to have a predetermined pattern so that the user may perceive a three-dimensional effect when the light passes through the outer lens 200. FIG. 5 illustrates a structure in which the pattern is formed in a lattice shape. It is effective that, in addition to the lattice shape, the pattern may be formed as a pattern in which triangular shapes, pentagonal shapes, hexagonal shapes, octagonal shapes, or the like are disposed repeatedly.

Meanwhile, as illustrated in FIG. 7, the vehicle lamp according to the present invention may be provided with a second lens (400) in front of the first lens (200) to uniformly lower the light transmittance along the direction of propagation of light generated from the light source (100). The second lens (400) is formed to have a smoky color tinged with light and is placed in front of the first lens (200), thereby resolving the problem of color difference due to thickness differences by pattern that may occur when only the first lens (200) is provided.

That is, by additionally positioning the second lens (400) in front of the first lens (200), two lenses are provided, enabling all surfaces to be uniformly black when the light source (100) is not illuminated, even if a difference in the thickness of the first lens (200) is formed.

According to the lamp for a vehicle according to the present disclosure configured as described above, the single outer lens is used as a lens installed in the lamp for a vehicle to implement a three-dimensional effect and a gradation pattern, thereby removing structural complexity, simplifying the manufacturing process, and miniaturizing the optical system.

While the embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A vehicle lampcomprising:
a light source configured to emit light; and
an outer lens disposed forward of the light source in a propagation direction of the light emitted from the light source,
wherein the outer lens is configured to transmit the light emitted from the light source, and has a thickness that varies in a vertical direction.

2. The lamp of claim 1, wherein the thickness of the outer lens increases or decreases in a stepwise manner along a height direction of the outer lens when the outer lens is oriented vertically.

3. The lamp of claim 2, wherein a light transmittance reduction portion configured to reduce light transmittance is provided in a boundary region where the thickness of the outer lens varies.

4. The lamp of claim 3, wherein the light transmittance reduction portion comprises a blocking member applied or printed with a predetermined thickness on a surface of the boundary region and configured to block forward transmission of the light.

5. The lamp of claim 3, wherein the light transmittance reduction portion comprises:
a protruding member protruding from a surface of the boundary region in a thickness direction of the outer lens; and
a blocking member applied or printed at an end of the protruding member opposite to an emission direction of the light and configured to block forward transmission of the light.

6. The lamp of claim 5, wherein a thickness of the protruding member in the vertical direction is smaller or larger than a thickness of a recessed portion in the vertical direction.

7. The lamp of claim 4, wherein the boundary region, on which the blocking member is applied or printed with a predetermined thickness, has an indented portion recessed inward.

8. The lamp of claim 4, wherein the blocking member is formed in a predetermined pattern configured to allow perception of a three-dimensional effect when the light passes through the outer lens.

9. The lamp of claim 1, further comprising a second lens installed in front of the outer lens and configured to uniformly reduce light transmittance along the propagation direction of light generated from the light source.

10. The lamp of claim 1, wherein the light source comprises a surface light emitter configured to emit light along a predetermined height.

11. The lamp of claim 1, wherein the light source comprises an indirect reflective surface optical system in which the light is emitted from one side thereof, a reflector is configured to reflect the emitted light forward, and a light diffusion film is disposed forward of the reflector.
